(19) United States
(12) Patent Application Publication
(10) Pub. No.: US 2012/0091824 A1
(43) Pub. Date: Apr. 19, 2012

(54) Electric Vehicle Supply Equipment with Line Fitting Disconnect Sensing

(75) Inventors: Steve Campolo, Malvern, NY (US); Kenneth J. Brown, Chula Vista, CA (US); Carlos E. Ramirez, San Diego, CA (US); Victor Soto, Escondido, CA (US); Sural Yegin, Chula Vista, CA (US)

(73) Assignee: LEVITON MANUFACTURING CO., INC., Melville, NY (US)

(21) Appl. No.: 12/907,808

(22) Filed: Oct. 19, 2010

(51) Int. Cl. H01H 9/30

(52) U.S. Cl. 307/135

(57) ABSTRACT

A system includes an electric vehicle supply circuit adapted to supply electric power to an electric vehicle, a line fitting arranged to connect the electric vehicle supply circuit to a source of electric power, and a sensor arranged to detect when the line fitting is being disconnected from the source of electric power. The electric vehicle supply circuit is adapted to interrupt the supply of electric power to the electric vehicle in response to the sensor to interrupt the flow of power through the electric vehicle supply circuit before the line fitting is disconnected from the power source.

### BACKGROUND

FIG. 1 illustrates a typical arrangement for charging an electric vehicle (EV) or plug-in hybrid electric vehicle (PHEV). Electric vehicle supply equipment (EVSE) 10 receives AC electric power from receptacle 12 through a line-side plug 14 and cord 16. The EVSE transfers the electric power to the vehicle 12 through a vehicle-side cord 20 and charge coupler 22 that plugs into a mating inlet 24 on the vehicle. In this example, the AC power is converted to DC power by an on-board charger 26 in the vehicle to charge the battery 28. In an alternative arrangement, the charger may be located in the EVSE instead of the vehicle.

The EVSE, which is also referred to as supply equipment, a vehicle charger, a charging station, a charger, etc., may be realized in several different mechanical configurations. EVSE are frequently installed as wall-mounted units in garages and on buildings where vehicles can be parked inside or close to the building. In outdoor locations, especially parking lots and curbsides, EVSE are commonly installed on pedestals. EVSE may also take the form of a cord set which is sometimes referred to as a travel charger, portable charger, handheld charger, etc.

The charge coupler 22 and inlet 24 typically utilize a conductive connection in which the electrical conductors in the coupler make physical contact with the electrical conductors in the inlet. Other systems utilize inductive coupling in which energy is transferred through magnetic coils that are electrically insulated from each other.

To promote interoperability of vehicles and supply equipment, the Society of Automotive Engineers (SAE) has developed various standards that define mechanical configurations of couplers for charging vehicles, as well as the arrangement and function of electrical contacts within the couplers. One standard known as SAE J1772 is of particular interest because virtually every automaker in the U.S., Japan and Europe has announced plans to use J1772 compatible couplers for models sold in the U.S. This standard relates to conductive charging systems and covers both AC and DC charging.

In accordance with National Electrical Code (NEC) article 625, for some EVSE, a mechanism must be provided to prevent the charge coupler from breaking the primary flow of load current when charging the vehicle. If removal of the charge coupler is attempted while power is flowing, an automatic disconnect device must activate, thereby interrupting the flow of power prior to disconnecting power at the charge coupler.

To comply with this requirement, the charge coupler typically includes a control pilot contact that is configured for last make/first break operation. Thus, as the charge coupler is removed from the mating inlet on the vehicle, the control pilot contact breaks, thereby causing the EVSE to de-energize the charge coupler, before the AC power contacts in the charge coupler break. This prevents arcing that may otherwise occur if the AC power contacts were to break while carrying the full load current.

### BRIEF DESCRIPTION OF THE DRAWINGS

FIG. 1 illustrates a typical arrangement for charging an electric vehicle.

FIG. 2 illustrates an embodiment of an EVSE system according to some inventive principles of this patent disclosure.

FIG. 3 illustrates another embodiment of an EVSE system according to some inventive principles of this patent disclosure.

FIG. 4 illustrates another embodiment of an EVSE system according to some inventive principles of this patent disclosure.

FIG. 5 illustrates another embodiment of an EVSE system according to some inventive principles of this patent disclosure.

FIG. 6 illustrates another embodiment of an EVSE system according to some inventive principles of this patent disclosure.

FIG. 7 illustrates another embodiment of an EVSE system according to some inventive principles of this patent disclosure.

FIG. 8 illustrates a cross-sectional view of an embodiment of a plug having a switch to detect when the plug is being disconnected from a receptacle according to some inventive principles of this patent application.

FIG. 9 illustrates a cross-sectional view of an embodiment of a plug having a magnetic sensor to detect when the plug is being disconnected from a receptacle according to some inventive principles of this patent application.

FIG. 10 illustrates an embodiment of an electric vehicle supply circuit according to some inventive principles of this patent disclosure.

FIG. 11 illustrates another embodiment of an electric vehicle supply circuit according to some inventive principles of this patent disclosure.

FIG. 12 illustrates an embodiment of a controller 180 according to some inventive principles of this patent disclosure.

FIG. 13 illustrates an embodiment of a plug-in EVSE module or device according to some inventive principles of this patent disclosure.

FIG. 14 illustrates an embodiment of an EVSE wiring device according to some inventive principles of this patent disclosure.

FIG. 15 illustrates another embodiment of an EVSE wiring device according to some inventive principles of this patent disclosure.

FIG. 16 illustrates another example EVSE apparatus according to some inventive principles of this patent disclosure.

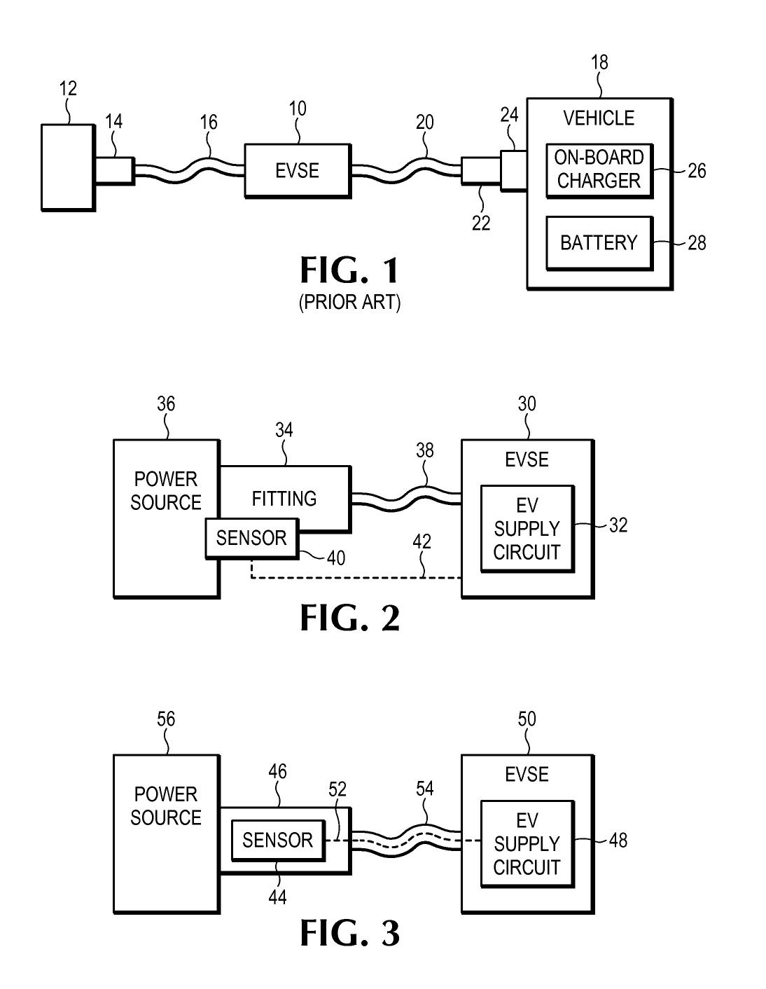

### DETAILED DESCRIPTION

For convenience, the term electric vehicle will be used to refer to pure electric vehicles (EVs), plug-in hybrid electric vehicles (PHEVs), and any other type of vehicle that utilizes electric charging unless otherwise apparent from context.

Substantiation-interlocks and automatic de-energization are required for the charging (vehicle) side of an EVSE, yet not for the primary (line) side connection. A cord-connected plug may serve as the disconnect means for some EVSE (e.g., 30 and 50 ampere plug-and-cord connected EVSE). If such a plug is removed from the corresponding receptacle under load, it may draw a considerable arc.

Some inventive principles of this patent disclosure relate to methods and apparatus for detecting when a line fitting such as a plug for an EVSE is being disconnected from the source of electric power and interrupting the supply of electric power before the line fitting is disconnected.

FIG. 2 illustrates an embodiment of an EVSE system according to some inventive principles of this patent disclosure. In the embodiment of FIG. 2, EVSE 30 includes an electric vehicle supply circuit 32. An electric vehicle supply circuit is designed to provide power to an electric vehicle from a power source and includes at least an interrupting device and control circuitry to cause the interrupting device to interrupt the flow of power from the power source to the electric vehicle in response to conditions relevant to electric vehicles. Examples of conditions relevant to electric vehicles include a ground fault condition, an inoperable grounding monitor circuit, the absence of a vehicle connected to the EVSE, absence of a ready signal from the vehicle, etc.

The embodiment of FIG. 2 also includes a line fitting 34 arranged to connect the electric vehicle supply circuit 32 to a source of electric power 36 through a power cord 38. A sensor 40 is provided to detect when the line fitting 34 is being disconnected from the source of electric power 36. The electric vehicle supply circuit 32 is adapted to interrupt the supply of electric power to the electric vehicle in response to the sensor 40, which communicates with the electric vehicle supply circuit 32 through a connection 42.

Detecting when the line fitting is “being disconnected” includes detecting anything that indicates that the line fitting has been, or is about to be, disconnected from the source of electric power. For example, the sensor may be arranged to detect any significant movement of the line fitting away from the power source. Preferably, the movement is detected before the line fitting has moved enough to interrupt the supply of power. Thus, the electric vehicle supply circuit may interrupt the supply of electric power in response to the sensor before the line fitting is completely disconnected, thereby prevent arcing that may occur if the line fitting is completely removed from the power source while under load.

The components illustrated in FIG. 2 may be realized in any suitable form. For example, the line fitting 34 may be implemented with a flat-blade plug, a sleeve-type plug, etc., while the power source 36 may include a corresponding flat-blade receptacle, pin-type receptacle, etc. The sensor 40 may include a mechanical switch, an additional set of contacts such as a last make/first break set of flat-blade or pin-and-sleeve contacts, a proximity sensor such as a capacitive sensor or a magnetic sensor which, in turn, may include a Hall-effect sensor, a magnetic pick-up coil, etc., a photo-device such as a photo-interrupter, photodiode, phototransistor, photoresistor, etc., or any other type of sensor. For example, a photo-device may be mounted on the line fitting or power source in such a way that no significant light reaches the photo-device when the line fitting is completely connected to the power source, but as the line fitting is disconnected, light begins to reach the photo-device until a trip-point is reached indicating that the line fitting has been or is being disconnected.

The sensor 40 may also be arranged in any suitable mechanical and/or electrical configuration. For example, the sensor may be integral with, or separate from, the line fitting 34, or the power source 36. The sensor may be included as part of a module that interfaces the line fitting to the power source. The connection 42 may take any suitable form including a wired connection integral with, or separate from, the power cord 38, and/or a wireless connection such as radio frequency (RF), infrared (IR), etc.

The electric vehicle supply circuit 32 may interrupt the supply of electric power to the electric vehicle in any suitable manner. For example, the circuit may utilize a charging circuit interrupting device (CCID) that already exists in the circuit, or a separate switching device may be used.

FIG. 3 illustrates another embodiment of an EVSE system according to some inventive principles of this patent disclosure. In the embodiment of FIG. 3, the sensor 44 is integral with line fitting 46 and communicates with the electric vehicle supply circuit 48 in EVSE 50 through a hard-wired connection 52 in power cord 54. For example, the power cord may include relatively large conductors such as 6 through 12 gage conductors for AC power, while the communication connection may be implemented with one or more relatively small conductors such as 18 or 20 gage. The communication connection may include two dedicated conductors, or a single dedicated conductor may be used with an equipment ground serving as the return current path.

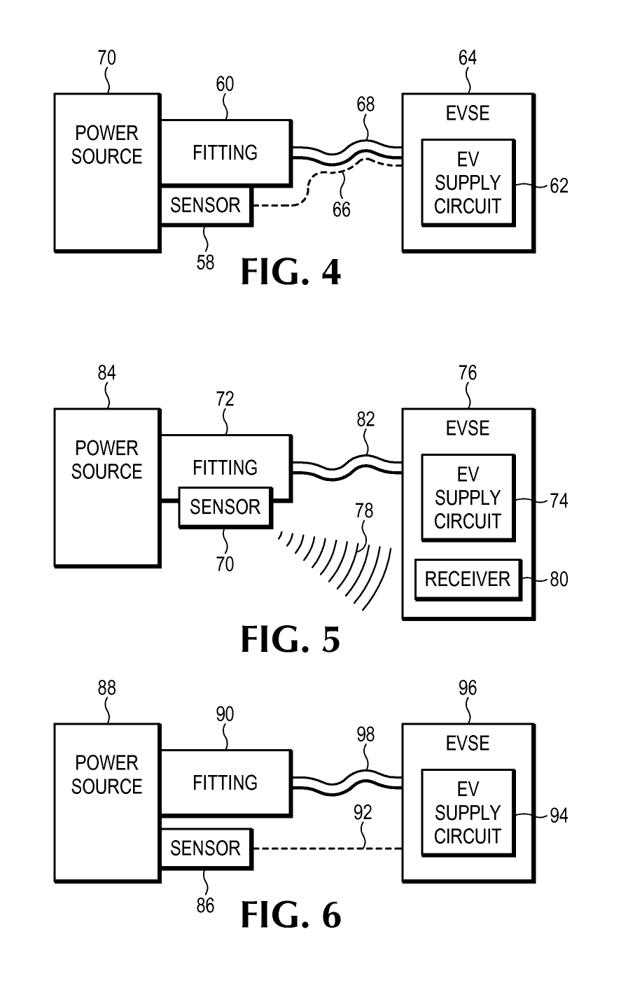

FIG. 4 illustrates another embodiment of an EVSE system according to some inventive principles of this patent disclosure. In the embodiment of FIG. 4, the sensor 58 is mounted on, but separate from, the line fitting 60 and communicates with the electric vehicle supply circuit 62 in EVSE 64 through a hard-wired connection 66 that is separate from the power cord 68. This configuration may be advantageous, for example, when retrofitting an existing EVSE system to include a line-side disconnect sensing feature.

FIG. 5 illustrates another embodiment of an EVSE system according to some inventive principles of this patent disclosure. In the embodiment of FIG. 5, the sensor 70 may be integral with, or separate from, the line fitting 72, but the sensor communicates with the electric vehicle supply circuit 74 in EVSE 76 through a wireless connection 78. Thus, a wireless receiver 80 may be included to interface the electric vehicle supply circuit to the sensor.

FIG. 6 illustrates another embodiment of an EVSE system according to some inventive principles of this patent disclosure. In the embodiment of FIG. 6, the sensor 86 is integral with or mounted on the power source 88 rather than the line fitting 90. The connection 92 between the sensor 86 and the electric vehicle supply circuit 94 in EVSE 96 is preferably a wireless connection, but a wired connection may also be used.

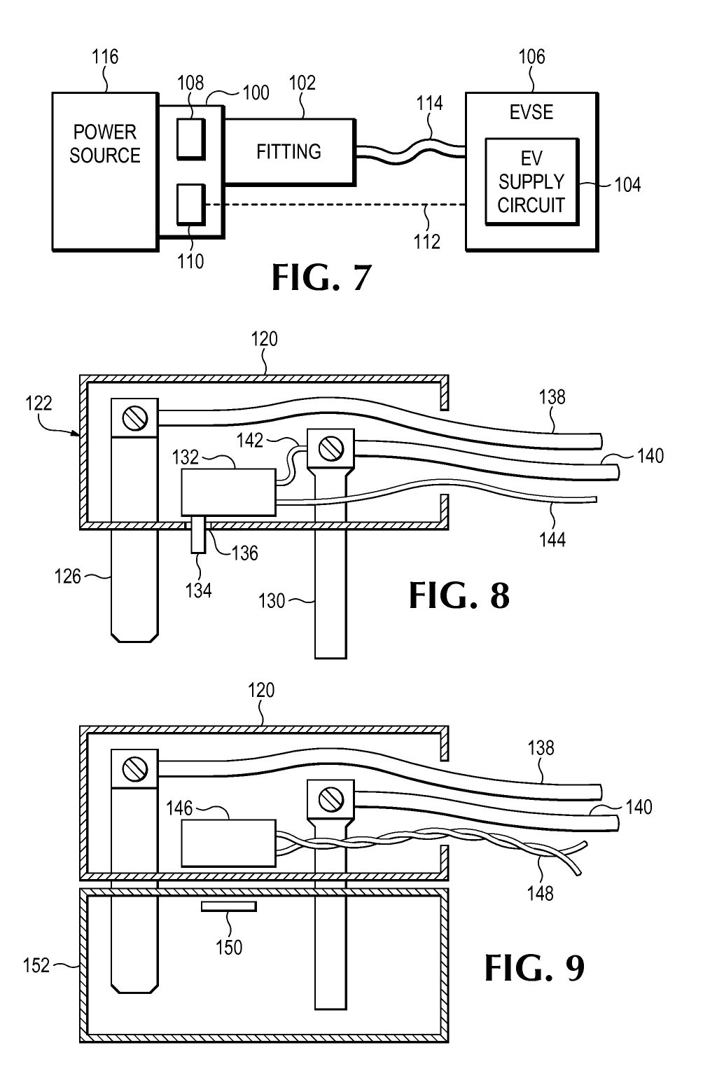

FIG. 7 illustrates another embodiment of an EVSE system according to some inventive principles of this patent disclosure. The embodiment of FIG. 7 includes a module 100 adapted to provide electric power to a line fitting 102 for an electric vehicle supply circuit 104 in EVSE 106. The module includes a sensor 108 arranged to detect when the line fitting 102 is being disconnected from the module 100, and a transmitter 110 adapted to transmit a signal over a connection 112 to interrupt the flow of power through the electric vehicle supply circuit before the line fitting is disconnected from the module.

FIG. 8 illustrates a cross-sectional view of an embodiment of a plug having a switch to detect when the plug is being disconnected from a receptacle according to some inventive principles of this patent application. The plug of FIG. 8 may be suitable for implementing the line fitting 46 shown in FIG. 3. In the example of FIG. 8, the plug is implemented as a NEMA 6-50 device having a plastic housing 120, but the inventive principles are not limited to any of these specific details. The housing includes a face portion 122 having a slot for one of the line terminal blades 126, and another opening for the ground terminal 130. The sensor in this embodiment is implemented as a microswitch 132 having a plunger-type actuator 134 that protrudes through an opening 136 in the face of the housing. Thus, the plunger 134 actuates the contacts in the microswitch when the plug is fully engaged in a receptacle and the face of the housing is pressed against the face of the receptacle. As the plug is removed from the receptacle, the plunger moves to its extended position, and the contacts in the microswitch return to their normal state well before the terminal blades disengage from the corresponding contacts in the receptacle.

Conductors 138 and 140 connect the line and grounding terminals to the EVSE. Conductor 142 connects one side of the microswitch contacts to the grounding terminal, while conductor 144 runs through the power cord with conductors 138 and 140. Conductors 138 and 140 are relatively heavy gauge conductors because they carry the full load current used to charge the vehicle, while conductors 142 and 144 may be relatively light gauge conductors because they only carry signal current. Another relatively heavy gauge conductor (not shown) connects the other line terminal to the EVSE.

FIG. 9 illustrates a cross-sectional view of an embodiment of a plug having a magnetic sensor to detect when the plug is being disconnected from a receptacle according to some inventive principles of this patent application. This embodiment is similar to the embodiment of FIG. 8 except that a Hall effect sensor 146 is used instead of a microswitch. Depending on the sensitivity of the sensor, the opening in the face of the housing may be eliminated as shown in FIG. 9. In this example, a pair of wires 148 is used to connect the sensor to control circuitry in the EVSE, although in other embodiments, the sensor may be wired with a common ground connection and a single conductor running back to the EVSE as in the embodiment of FIG. 8. The pair of wires 148 may optionally be twisted to reduce noise on the low-level signals carried on the wires. A magnet 150 may be mounted in or under the face 152 of the receptacle to induce a signal in the Hall effect sensor when the plug is fully engaged in the receptacle.

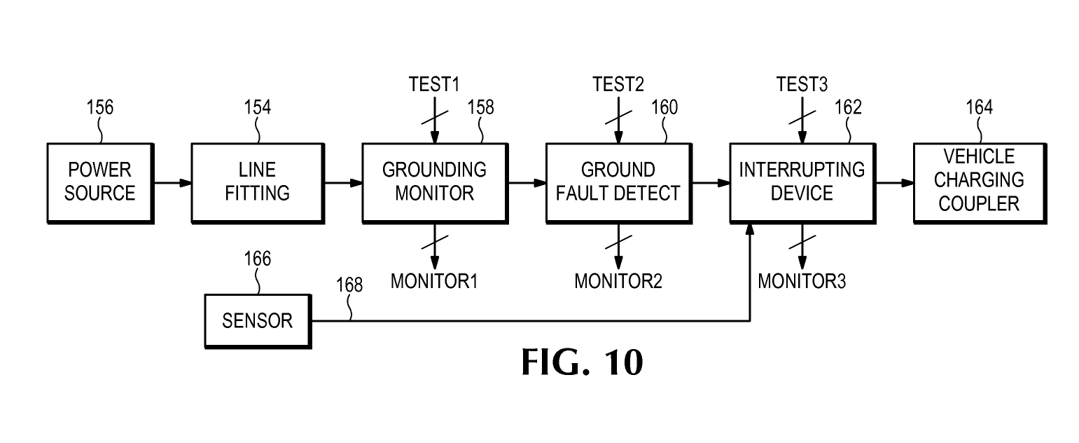

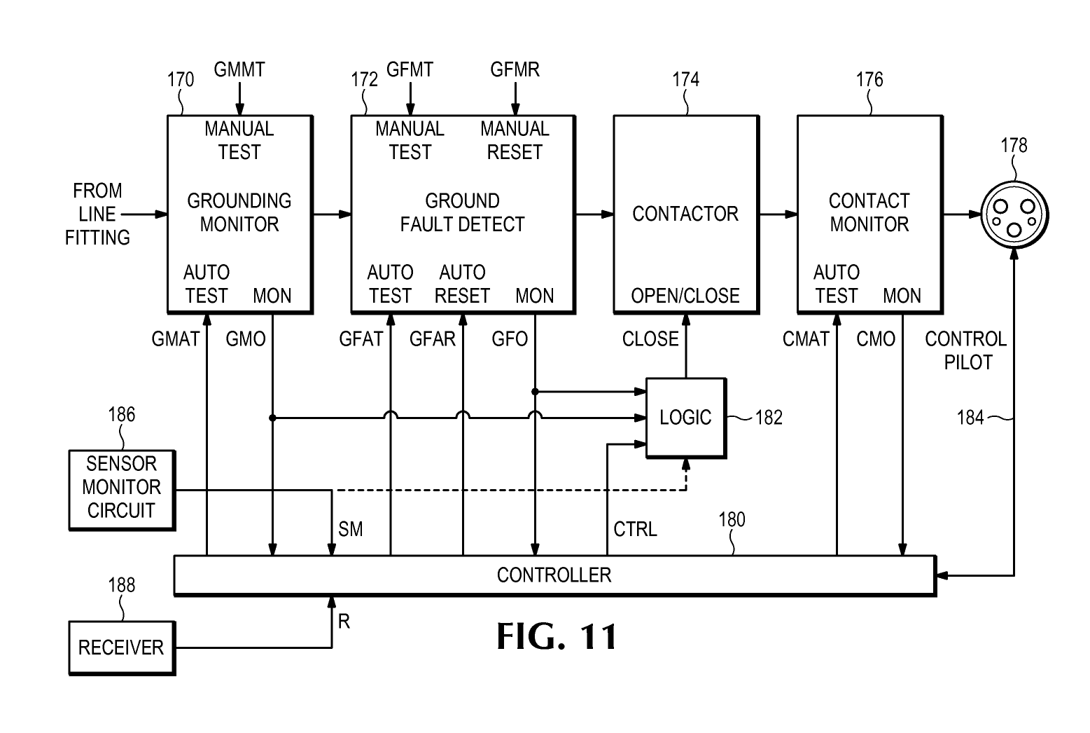

FIG. 10 illustrates an embodiment of an electric vehicle supply circuit according to some inventive principles of this patent disclosure. The embodiment of FIG. 10 includes a line fitting 154 to connect the electric vehicle supply circuit to a power source 156. The circuit also includes a grounding monitor 158, a ground fault detector 160, and an interrupting device 162 arranged along a power path between the line fitting 154 and a vehicle charging coupler 164. A sensor 166, which is arranged to detect when the line fitting is being disconnected from the power source, is connected through a connection 164 to the interrupting device 162 which is adapted to interrupt the supply of electric power to the electric vehicle in response to the sensor.

The power path may accommodate AC and/or DC current flow. Any or all of the ground monitor, ground fault detector and/or interrupting device may include one or more test inputs TEST1, TEST2, TEST3, respectively, and one or more monitor outputs MONITOR1, MONITOR2, MONITOR 3, respectively. The test inputs may include any type of analog, digital or hybrid signals for initiating, controlling, resetting, etc., a testing operation. The monitor outputs may include any type of analog, digital or hybrid signals for monitoring, measuring, reporting, etc., a testing operation. Any of the testing and/or monitoring signals may operate manually, automatically, or in any other suitable manner. Not all of the elements are required in every embodiment, and the number, order and arrangement of elements may be changed.

FIG. 11 illustrates another embodiment of an electric vehicle supply circuit according to some inventive principles of this patent disclosure. Power is provided by a line fitting and flows through a grounding monitor circuit 170, a ground fault detecting circuit 172, a contactor circuit 174, and a contact monitor circuit 176 on the way to a vehicle charging coupler 178. These components may be reordered and/or rearranged in any suitable manner.

The grounding monitor circuit 170 monitors the continuity of a grounding conductor and generates an output signal GMO in response to the state of the grounding conductor. A manual test input GMMT enables the operation of the grounding monitor to be tested manually. An automatic test input GMAT enables the operation of the grounding monitor to be tested in response to an automatic test signal from a controller 180. The output signal GMO is provided to the controller 180 as well as logic 182.

The embodiment of FIG. 11 may include either or both of a sensor monitor circuit 186 and/or a receiver 188. The sensor monitor circuit 186 may be used to determine the state of a switch such as microswitch 132 in the embodiment of FIG. 8 or to measure the output of a proximity sensor such as the Hall effect sensor in the embodiment of FIG. 9. The receiver 188 may be used to establish the connection between the electric vehicle supply circuit and any of the sensors illustrated in FIGS. 5-7.

The output signal SM from the switch monitor circuit 186 may be applied to the controller 180 which may then control the contactor 174 in response to the state of the switch. Additionally, or alternatively, the output signal SM from the switch monitor circuit 186 may be applied directly to logic 182 to enable the switch to directly control the state of the contactor. Similarly, the output signal R from receiver 188 may be applied to the controller 180 and/or logic 182 to control the contactor directly, or through the controller 180.

The ground fault detecting circuit 172 monitors the differential current through the current carrying conductors and changes the state of the output signal GFO if the differential current exceeds a threshold. A manual test input GFMT enables the operation of the ground fault detector to be tested manually, while a manual reset input GFMR allows the detector to be reset manually. Automatic test input GFAT and automatic reset input GFAR enable the controller 180 to test and reset the ground fault detector. The output signal GFO is applied to the controller 180 as well as logic 182.

The contactor circuit 174 is arranged to close the circuit between the power source and the vehicle coupler 178 in response to a CLOSE input signal from logic 182.

The contact monitor circuit generates an output signal CMO in response to the state of one or more switches in the contactor circuit 174. An automatic test input CMAT enables the controller 180 to test and monitor the contactor circuit.

A control pilot connection 184 enables the controller to determine whether a vehicle is connected to the supply circuit, to determine whether the vehicle is ready to receive power, to communicate the current capacity of the supply circuit to the vehicle, etc.

Logic 182 may be configured for interlocking operation. For example, the logic may be configured to assert the CLOSE signal only if the GMO signal indicates that the grounding monitor circuit is operating properly, the GFO signal indicates that no ground fault is present, the controller asserts the CTRL signal, and the sensor 186 and/or receiver 188 indicate that the line fitting is not being disconnected from the power source.

The controller 180 may be configured to operate any or all of the features illustrated in FIG. 10. For example, the controller may be configured to test the grounding monitor 170, the ground fault detector 172, the contactor circuit 174 and/or contact monitor 176 at power-up, each time power is applied to the vehicle, periodically while power is being supplied to the vehicle, etc. The contact monitor circuit enables the controller to monitor the presence of power to determine that the switch or switches in the contactor circuit 174 have actually closed when the CLOSE signal is activated and have actually opened when the CLOSE signal is deactivated and to provide a warning or take other suitable action if the actual state of the contactor circuit is incorrect or if some other fault causes the output power to be in an incorrect state.

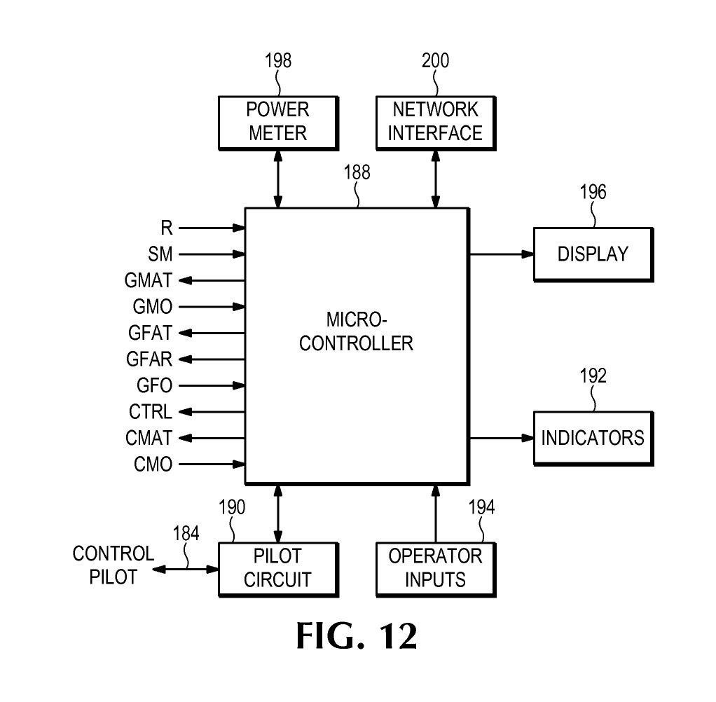

FIG. 12 illustrates an embodiment of a controller 180 according to some inventive principles of this patent disclosure. The controller is based on a microcontroller 188, although some or all of the functions of the controller may be implemented with any other suitable analog and/or digital hardware, software, firmware, etc., or any combination thereof. Not all of the elements shown in FIG. 12 are required in every embodiment, and the number, order and arrangement of elements may be changed.

The microcontroller 188 includes digital I/O lines coupled to the test, monitor and reset signals shown in FIG. 11. The controller may include filters, surge suppressors, buffers, amplifiers, comparators, level shifters, level detectors, additional logic, etc., to process these signals on their way to and from the microcontroller. A pilot circuit 190 provides functionality to enable the controller to determine whether a vehicle is connected to the supply circuit, to determine whether the vehicle is ready to receive power, to communicate the current capacity of the supply circuit to the vehicle, to monitor the integrity of the grounding connection, etc., through the control pilot connection 184.

Indicators 192 such as LEDs, lamps, etc. enable the controller to provide a visual indication of the operating condition of the vehicle supply circuit, fault conditions, etc. Some example indicators include a vehicle charging indicator and an EVSE fault indicator. Operator inputs 194 such as switches, keypads, swipe cards, RFID devices, etc., enable a user to control the operation of the vehicle supply circuit. Some example inputs include switches to start/stop charging, switches to increase/decrease amperage, etc.

A display 196 enables the controller to provide more information to a user than may be conveyed through simple indicators. For example, an alphanumeric display may display vehicle charging current, voltage and/or power, percentage of charging completed, elapsed charging time, cost of power, etc. A display may also provide more detailed information about fault conditions and/or instructions for correcting faults.

A power meter 198 or other device may provide functionality to measure the amount of power transferred through the vehicle supply circuit. A network interface 200 may enable the controller to interface to any suitable network such as a local area network (LAN), wide area network (WAN), home network, the Internet, a control area network (CAN) or other industrial type control network, etc., through any type of network media and using any type of network protocol. Examples include dedicated wires, power line modulation, radio frequency (RF), infrared (IR), and other types of media, Internet Protocol (IP), WiFi, LonWorks, ZigBee, Z Wave, and other types of protocols. Any of these communication technologies may be used to implement the connections between the sensors and electric vehicle supply circuits described above.

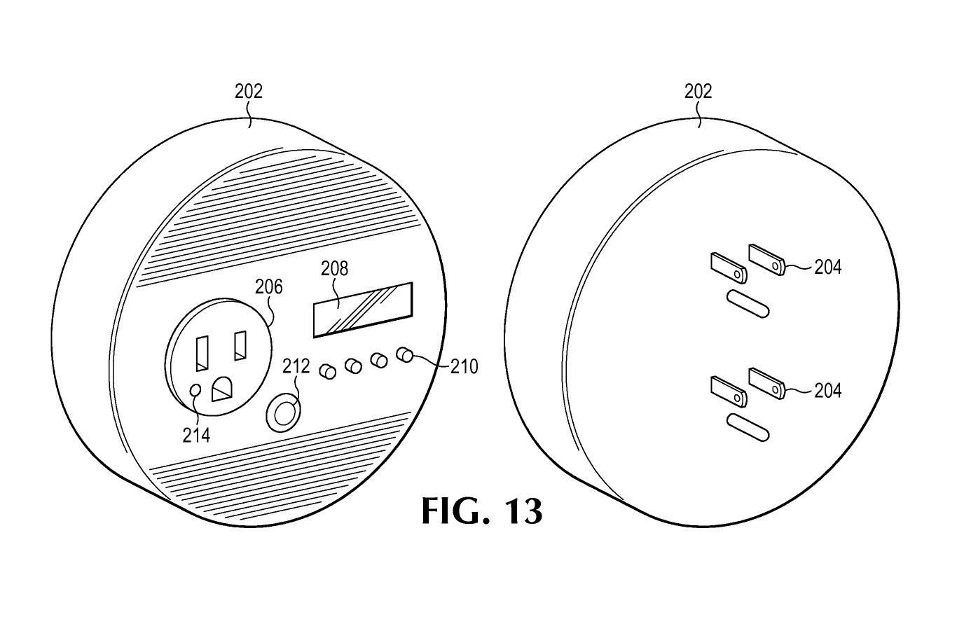

FIG. 13 illustrates an embodiment of a plug-in EVSE device according to some inventive principles of this patent disclosure. The device of FIG. 13, which may be used to implement, for example, the module 100 illustrated in FIG. 7, includes a housing 202 having one or more sets of blades 204 or other connections on the back for plugging the device into one or more receptacles. The device also includes a receptacle 206 on the front to provide power to a vehicle through, for example, an EVSE cord set. Any type and extent of vehicle supply circuitry may be included within the device.

For example, in one embodiment the device may not be able to disconnect the receptacle 206 from the blades 204. The device may include monitoring circuitry to display charging voltage, current, power, etc., on a display 208. Buttons 210 may enable a user to select a parameter to view, scroll through various parameters or menu items, etc.

In another embodiment, the plug-in device of FIG. 13 may include a charging circuit interrupting device (CCID) to interrupt power to the receptacle 206 if a ground fault is detected. Another embodiment may include a CCID and a grounding monitor to enable the trip point of the CCID to be set to a relatively high level. In other embodiments, the device of FIG. 13 may include any or all of the manual and/or automatic testing and/or monitoring features described above with respect to the embodiments of FIGS. 10-12.

The device of FIG. 13 may include a transmitter 212 adapted to transmit a signal to interrupt the flow of power through an electric vehicle supply circuit before the line fitting is disconnected from the module. In some embodiments, a sensor 214 such as a switch or proximity sensor may be integrated directly into the face of the receptacle.

If used to implement the module 100 illustrated in FIG. 7, the device of FIG. 13 may be adapted to be fastened to the source of electrical power, in this case an underlying receptacle, so that the module does not pull out of the underlying receptacle when the plug is removed from the receptacle on the module. The module may be fastened, for example, with screws that engage the threaded holes that would normally be used to attach a face plate, but which may be omitted if the device of FIG. 13 is fastened to the underlying receptacle.

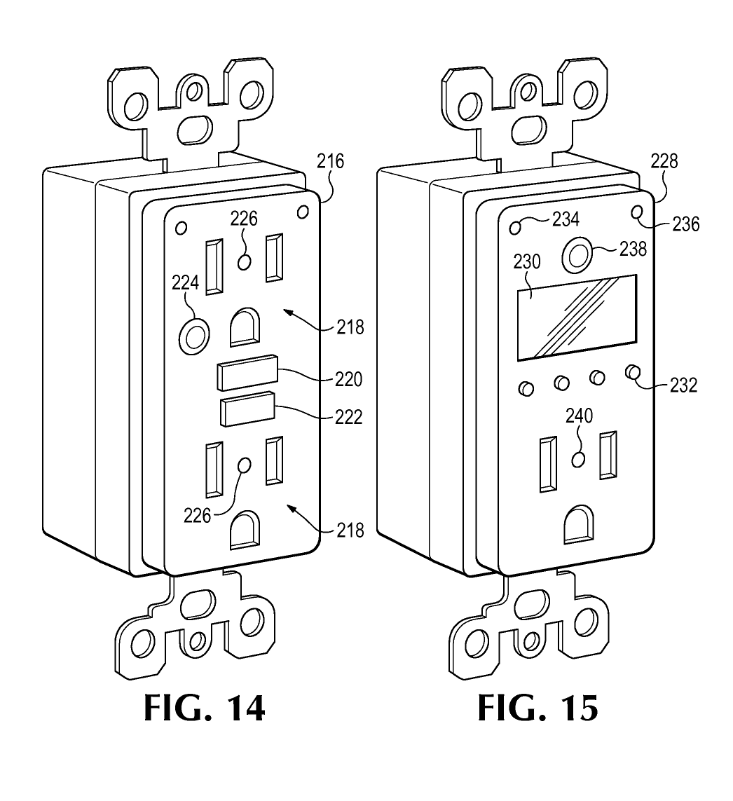

FIG. 14 illustrates an embodiment of an EVSE wiring device according to some inventive principles of this patent disclosure. The embodiment of FIG. 14, which may be used to implement, for example, the module 100 illustrated in FIG. 7, has a housing 216 with a form factor and circuitry that is similar to a standard GFCI wiring device (or arc-fault circuit interrupter (AFCI), equipment leakage circuit interrupter (ELCI), overcurrent, overvoltage, or any other suitable circuit interrupter). However, a grounding monitor circuit may be added to enable the ground fault trip point to be set to a relatively high level to accommodate vehicle charging. A vehicle may be plugged into the device with an EVSE cord set having a plug that fits into one of the receptacles 218. Test and reset buttons 220 and 222 are located on the front. In some embodiments, the ground fault detection and grounding monitor functionality may have manual test and reset features. In other embodiments, one or both of the ground fault detection and grounding monitor functionality may include automatic test and/or reset features such as those described above with respect to FIGS. 10-12.

The device of FIG. 14 may include a transmitter 224 adapted to transmit a signal to interrupt the flow of power through an electric vehicle supply circuit before the line fitting is disconnected from the module. In some embodiments, one or more sensors 226 such as a switch or proximity sensor may be integrated directly into the face of the receptacle.

FIG. 15 illustrates another embodiment of an EVSE wiring device according to some inventive principles of this patent disclosure. The embodiment of FIG. 15, which may also be used to implement, for example, the module 100 illustrated in FIG. 7, has a housing 228 with a form factor similar to the embodiment of FIG. 14. However, one of the front receptacles is replaced with a display 230 and buttons 232 which may have functionality similar to that described above with respect to FIG. 14. Additionally, the embodiment of FIG. 15 may include one or more indicators 234 and 236 such as LEDs, lamps, audio indicators, tactile indicators, etc., to indicate vehicle charging state, fault conditions, etc. As with the embodiments of FIGS. 13 and 14, any type and extent of vehicle supply circuitry may be included within the device.

The device of FIG. 15 may include a transmitter 238 adapted to transmit a signal to interrupt the flow of power through an electric vehicle supply circuit before the line fitting is disconnected from the module. In some embodiments, a sensor 240 such as a switch or proximity sensor may be integrated directly into the face of the receptacle.

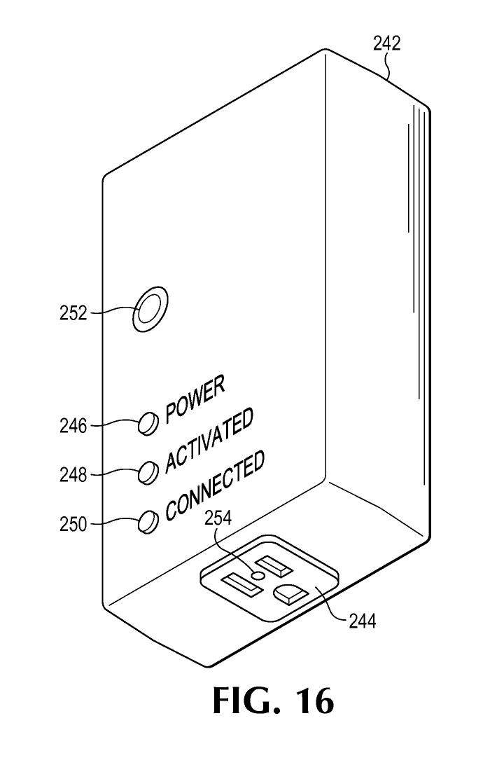

FIG. 16 illustrates another example EVSE apparatus according to some inventive principles of this patent disclosure. In this example, the electric vehicle supply circuit is housed in a plug-in adapter or module 242 having contact blades on the back similar the embodiment of FIG. 13. The embodiment of FIG. 16 may be used, for example, to implement the module 100 illustrated in FIG. 7. The embodiment of FIG. 16 also includes a receptacle 244 and a plurality of indicators including, for example, a power indicator 246 that indicates when AC power is applied to the unit and an active indicator 248 that indicates when AC power is applied to the receptacle 244 and/or vehicle charging coupler. For example, if the unit is implemented with the circuit of FIG. 10, the active indicator 248 may be configured to illuminate when the contactor is closed. Another indicator 250 indicates when a wireless connection is established by the unit.

The device of FIG. 16 may include a transmitter 252 adapted to transmit a signal to interrupt the flow of power through an electric vehicle supply circuit before the line fitting is disconnected from the module. In some embodiments, a sensor 254 such as a switch or proximity sensor may be integrated directly into the face of the receptacle.

The inventive principles of this patent disclosure have been described above with reference to some specific example embodiments, but these embodiments can be modified in arrangement and detail without departing from the inventive concepts. For example, even though some example embodiments are described in the context of EVSE systems, the inventive principles may also be applied to other types of power distribution systems. Thus, any changes and modifications are considered to fall within the scope of the following claims.

1. An electric vehicle supply equipment (EVSE) system comprising:
an electric vehicle supply circuit adapted to supply electric power to an electric vehicle;
at least one line fitting arranged to connect the electric vehicle supply circuit to a source of electric power; and
a sensor arranged to detect when the line fitting is being disconnected from the source of electric power;
where the electric vehicle supply circuit is adapted to interrupt the supply of electric power to the electric vehicle in response to the sensor.

2. The system of claim 1 where the sensor is integral with the line fitting.

3. The system of claim 1 where the sensor is integral with the source of electric power.

4. The system of claim 1 where the sensor is coupled to the electric vehicle supply circuit through a wired connection.

5. The system of claim 1 where the sensor is coupled to the electric vehicle supply circuit through a wireless connection.

6. The system of claim 1 where the sensor comprises a mechanical switch.

7. The system of claim 1 where the sensor comprises a proximity sensor.

8. The system of claim 1 where the line fitting comprises a plug connected to the electric vehicle supply circuit through a cord.

9. The system of claim 8 where the sensor is connected to the electric vehicle supply circuit through one or more conductors in the cord.

10. The system of claim 1 where the electric vehicle supply circuit comprises:
a charge circuit interrupting device; and
a controller configured to open the charge circuit interrupting device in response to the sensor.

11. The system of claim 1 further comprising a module adapted to couple the line fitting to the source of electric power.

12. The system of claim 11 where the sensor is integral with the module.

13. The system of claim 12 where the module comprises a transmitter to couple the sensor to the electric vehicle supply circuit.

14. The system of claim 13 where the sensor comprises a mechanical switch.

15. The system of claim 13 where the sensor comprises a magnetic sensor.

16. The system of claim 11 where:
the line fitting comprises a plug; and
the module comprises a receptacle for the plug.

17. The system of claim 11 where:
the sensor is integral with the line fitting; and
the module comprises an actuator for the sensor.

18. The system of claim 17 where:
the sensor comprises a magnetic sensor; and
the actuator comprises a magnet.

19. A method comprising:
coupling a line fitting to an electric receptacle;
providing electric power to an electric vehicle supply circuit through the line fitting;
detecting when the line fitting is being disconnected from a source of electric power; and
interrupting the flow of electric power through the electric vehicle supply circuit before the line fitting is disconnected from the source of electric power.

20. The method of claim 19 where the line fitting comprises a plug.

21. The method of claim 19 where detecting when the line fitting is being disconnected from the source of electric power comprises actuating a mechanical switch as the line fitting is being disconnected.

22. The method of claim 19 where detecting when the line fitting is being disconnected from the source of electric power comprises moving a magnet relative to a magnetic sensor.

23. The method of claim 19 further comprising transmitting a signal to the vehicle supply circuit in response to detecting when the line fitting is being disconnected from the source of electric power.

24. The method of claim 23 where the signal is transmitted through a wired connection.

25. The method of claim 19 where interrupting the flow of electric power comprises opening a charge circuit interrupting device in the electric vehicle supply circuit.
